(19) United States
(12) Patent Application Publication
(10) Pub. No.: US 2015/0106507 A1
(43) Pub. Date: Apr. 16, 2015

(54) SELECTION SYSTEM, SELECTION SERVER, SELECTION METHOD, AND COMPUTER READABLE MEDIUM

(71) Applicant: FUJI XEROX CO., LTD., Tokyo (JP)

(72) Inventors: Kazuhiro KANEKO, Kanagawa (JP); Takao MATSUOKA, Kanagawa (JP)

(73) Assignee: FUJI XEROX CO., LTD., Tokyo (JP)

(21) Appl. No.: 14/276,038

(22) Filed: May 13, 2014

(30) Foreign Application Priority Data
Oct. 11, 2013 (JP) 2013-213340

(51) Int. Cl. H04L 12/24; H04L 12/26

(52) U.S. Cl. CPC H04L 41/082; H04L 43/0817
USPC 709/224

(57) ABSTRACT

A selection system includes an acquiring unit, a candidate selecting unit, and a product selecting unit. The acquiring unit acquires device information of multiple devices. The candidate selecting unit selects, from among the multiple devices, a device whose device information does not meet a predetermined criterion, as a candidate for a device to be replaced. The product selecting unit selects, based on a selection result by the candidate selecting unit and product information regarding multiple products that meet the predetermined criterion, a device to be replaced, from among candidates selected, and a replacement product with which the device is to be replaced.

### CROSS-REFERENCE TO RELATED APPLICATIONS

This application is based on and claims priority under 35 USC 119 from Japanese Patent Application No. 2013-213340 filed Oct. 11, 2013.

### BACKGROUND

### Technical Field

The present invention relates to a selection system, a selection server, a selection method, and a computer readable medium.

### SUMMARY

According to an aspect of the invention, there is provided a selection system including an acquiring unit, a candidate selecting unit, and a product selecting unit. The acquiring unit acquires device information of multiple devices. The candidate selecting unit selects, from among the multiple devices, a device whose device information does not meet a predetermined criterion, as a candidate for a device to be replaced. The product selecting unit selects, based on a selection result by the candidate selecting unit and product information regarding multiple products that meet the predetermined criterion, a device to be replaced, from among candidates selected, and a replacement product with which the device is to be replaced.

### BRIEF DESCRIPTION OF THE DRAWINGS

Exemplary embodiments of the present invention will be described in detail based on the following figures, wherein:

FIG. 1 is a system configuration diagram of a selection system according to an exemplary embodiment of the invention;

FIG. 2 is a function block diagram of the selection system;

FIG. 3 is a diagram illustrating an example of license information;

FIG. 4 is a diagram illustrating an example of device information;

FIG. 5 is a diagram illustrating an example of a selection result by a candidate-to-be-replaced selecting unit;

FIG. 6 is a diagram illustrating an example of product information;

FIG. 7 is a diagram illustrating an example of product information;

FIG. 8 is a diagram illustrating an example of a selection result by a product candidate selecting part;

FIG. 9 is a diagram illustrating an example of weighting information;

FIG. 10 is a diagram illustrating an example of a calculation result by an importance calculating part;

FIG. 11 is a diagram illustrating an example of a selection result by a product selecting unit;

FIG. 12 is a sequence diagram illustrating an example of a process performed in the selection system; and

FIG. 13 is a flowchart illustrating an example of selection processing.

### DETAILED DESCRIPTION

### [1. Exemplary Embodiment]

An exemplary embodiment of the present invention will be described hereinafter with reference to drawings.

### [2. Configuration of Selection System]

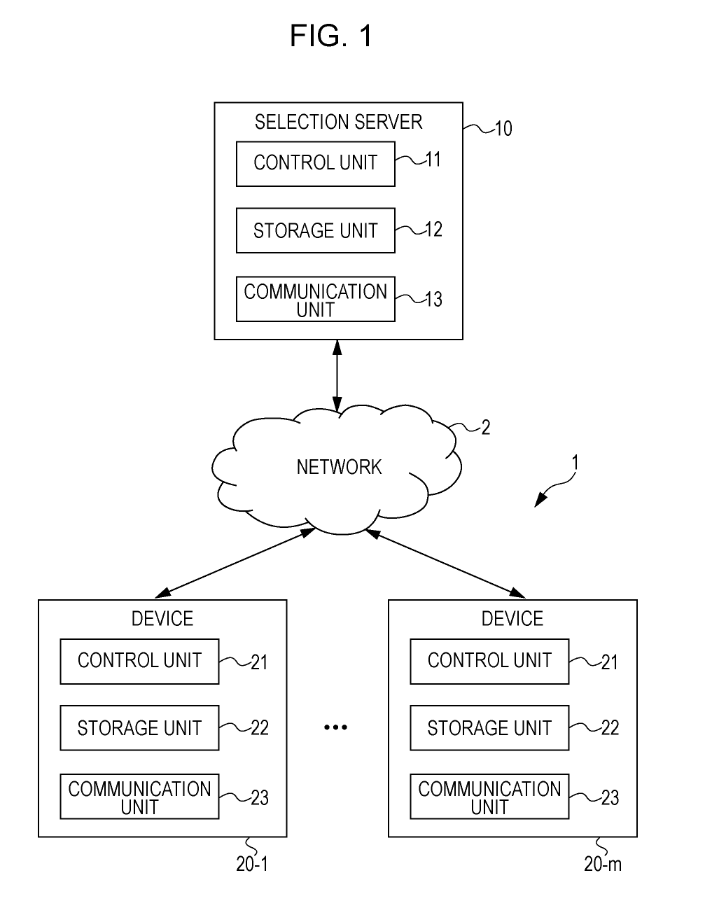

FIG. 1 is a system configuration diagram of a selection system according to an exemplary embodiment of the invention. As illustrated in FIG. 1, a selection system 1 is configured, for example, to include a selection server 10 and multiple devices 20 (20-1 to 20-m) (m represents an integer of 2 or more). The selection server 10 is connected to each of the devices 20 through a communication network 2.

The selection server 10 is implemented, for example, by a server computer or the like. The selection server 10 is configured to include, for example, a control unit 11 which is configured to include a central processing unit (CPU) and the like, a storage unit 12 which stores a program executed by the control unit 11 and various data, and a communication unit 13 which transmits and receives data to and from the devices 20 through the communication network 2. The selection server 10 may include, in addition to the above components, an operation unit which is configured to include an input device, such as a keyboard, a mouse, and a touch panel, and a display unit which is configured to include a monitor and the like.

The devices 20 are implemented, for example, by hardware of various computers such as a personal computer, a printer, a scanner, and a multifunction machine. The devices 20 are each configured to include, for example, a control unit 21 which is configured to include a CPU and the like, a storage unit 22 which stores a program executed by the control unit 21 and various types of information regarding the device 20, and a communication unit 23 which transmits and receives data to and from the selection server 10 through the communication network 2. The devices 20 may each include, in addition to the above components, an operation unit, a display unit, and the like.

The selection system 1 selects, for example, a candidate for a device 20 to be replaced or a candidate for a component to be replaced (for example, a CPU, a memory, a program, or the like) from among multiple devices 20, based on information of parts of the devices 20 (CPU usage, memory usage, and the like) and information of a program (version information, the release date and time at which the program was released, and the like) stored in the storage units 22 of the devices 20, as usage statuses of components of the devices 20. A candidate for a device 20 to be replaced or a candidate for a component to be replaced will also be referred to as a “candidate to be replaced”, or simply referred to as a “candidate”, hereinafter. The selection system 1 narrows down the above-mentioned candidates that truly need to be replaced, for example, by taking into consideration the budget of a user and the price of a replacement product or examining whether or not the above-mentioned candidate is indispensable. A detailed description of the configuration for realizing the above-mentioned processing will be provided hereinafter.

### [3. Function Group Implemented in Selection System]

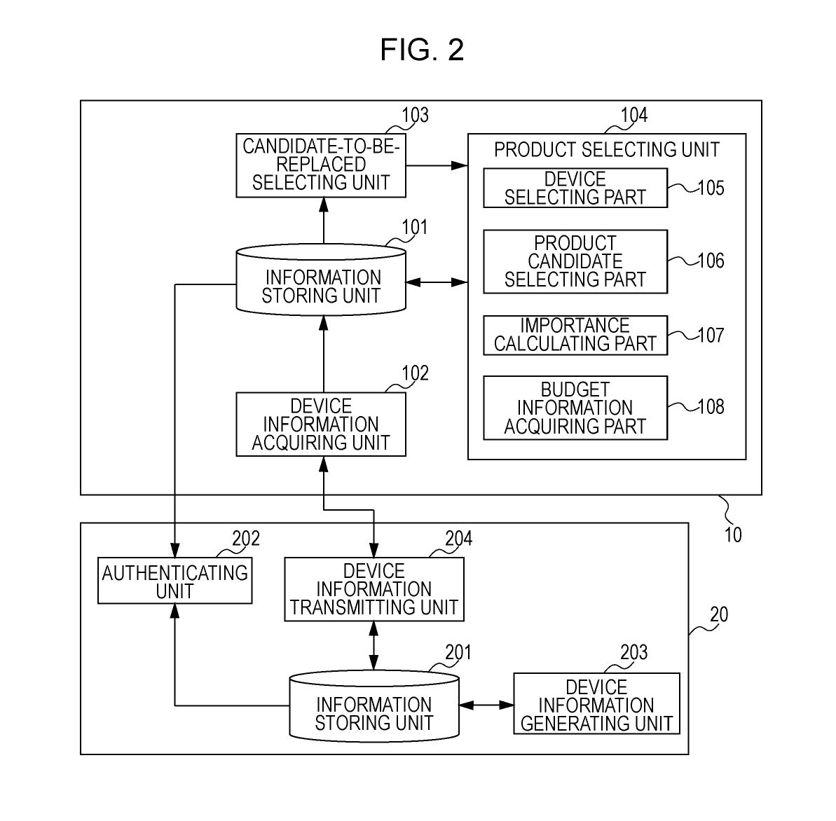

FIG. 2 is a function block diagram of the selection system 1. As illustrated in FIG. 2, the selection server 10 is configured to include, for example, an information storing unit 101, a device information acquiring unit 102, a candidate-to-be-replaced selecting unit 103, and a product selecting unit 104. Further, as illustrated in FIG. 2, the devices 20 are each configured to include, for example, an information storing unit 201, an authenticating unit 202, a device information generating unit 203, and a device information transmitting unit 204.

The individual functions illustrated in FIG. 2 are implemented, for example, by the control unit 11 of the selection server 10 executing a program stored in the storage unit 12 of the selection server 10, and by the control unit 21 of the device 20 executing a program stored in the storage unit 22 of the device 20. A detailed description of the above-mentioned function group will be provided hereinafter.

### [3-1. Information Storing Unit]

The information storing unit 101 is generally implemented by the storage unit 12. The information storing unit 101 stores various types of information to be referred to in selection processing, which will be described later, such as license information which indicates a list of license codes, device information, information which indicates a criterion set for each component of the devices 20, product information regarding multiple products, and weighting information which indicates an additional value of an importance. A detailed description of the above-mentioned information will be provided later.

The information storing unit 201 is generally implemented by the storage unit 22 of each of the devices 20. The information storing unit 201 stores various types of information regarding the device 20. The information storing unit 201 stores, for example, a device name and type for identifying the device 20, and information regarding components of the device 20. The expression “components of the device 20” mentioned here represents, for example, parts of the device 20 and a program stored in the storage unit 22.

The information storing unit 201 stores, for example, information for identifying parts of the device 20, such as the name of a CPU, the memory capacity, and the capacity of a hard disk drive (HDD) of the device 20. Further, the information storing unit 201 stores information regarding a program stored in the storage unit 22, such as the name and version information (or the release date) of a program. Specifically, information regarding a program includes version information (or the release date) of a basic input/output System (BIOS), an operating system (OS), software and firmware to implement various functions, a library required to operate software, and the like of the device 20.

### [3-2. Authenticating Unit]

The authenticating unit 202 is generally implemented by the control unit 21 and the communication unit 23 of each of the devices 20. The authenticating unit 202 acquires a license code, and based on the license code and license information stored in the information storing unit 101, approves execution of device information generation processing by the device information generating unit 203, which will be described later, and execution of device information transmission processing by the device information transmitting unit 204, which will be described later. For example, the license code may be used as authentication information required for executing the device information generating unit 203 and the device information transmitting unit 204, which will be described later, in the device 20, or may be used as information for identifying a group or budget described later.

The authenticating unit 202 acquires, for example, a license code through reception of input from a user. The information storing unit 201 may also store a license code regarding the device 20, and the authenticating unit 202 may acquire a license code from information stored beforehand in the information storing unit 201.

For example, the authenticating unit 202 refers to license information stored in the information storing unit 101 of the selection server 10 through the communication unit 23. When the acquired license code is not present in the license information, the authenticating unit 202 restricts the device information generating unit 203 so as not to execute device information generation processing described later and restricts the device information transmitting unit 204 so as not to execute device information transmission processing described later.

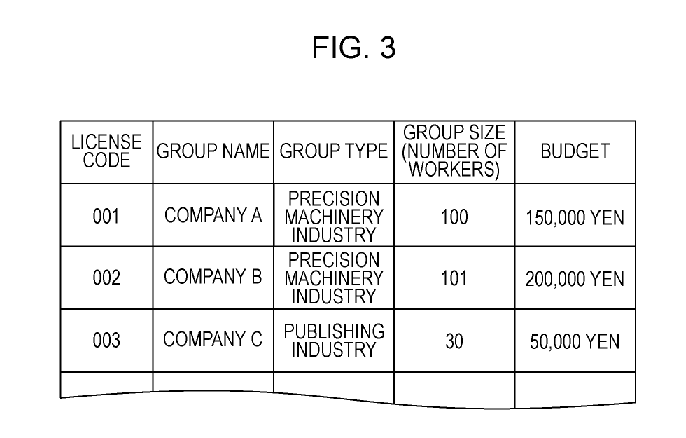

FIG. 3 is a diagram illustrating an example of license information. As illustrated in FIG. 3, for example, a license code, a group name for identifying a group associated with the license code, a group type indicating the type of a group, a group size indicating the size of a group, and budget information, are stored in license information. A group mentioned here represents a group to which a user and the device 20 belongs, that is, for example, a company, a section, a government office, a school, or the like. Further, information indicating a company name, an industry type, and the number of workers may be stored as a group name, a group type, and a group size, respectively, in license information.

The license information illustrated in FIG. 3 is merely an example and license information is not limited to this. License information may include, for example, a password regarding authentication processing of a license code or other types of information such as a device name for identifying the device 20.

### [3-3. Device Information Generation Unit]

The device information generating unit 203 is generally implemented by the control unit 21 of each of the devices 20. The device information generating unit 203 generates, for example, device information of the device 20, based on information regarding the device 20 stored in the information storing unit 201. Further, the device information generating unit 203 generates, for example, device information indicating the usage statuses of components of the device 20, based on information regarding the usage statuses of the components of the device 20 stored in the information storing unit 201.

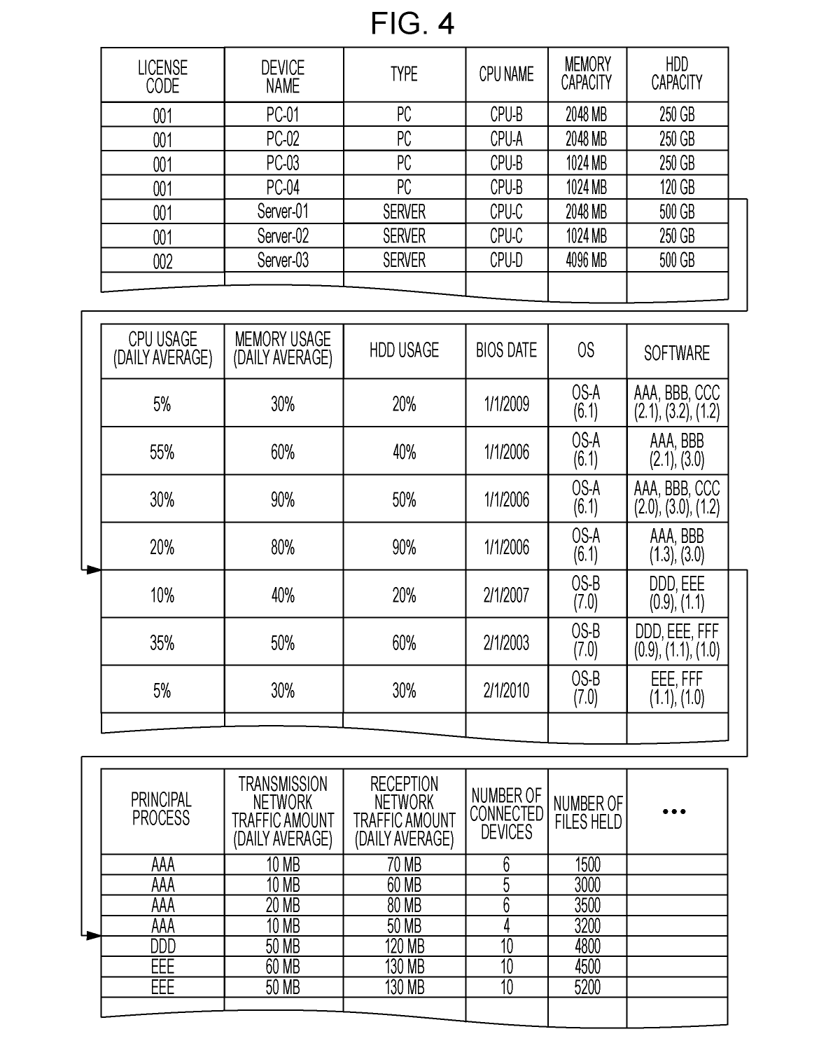

FIG. 4 is a diagram illustrating an example of device information. Information regarding multiple devices 20 is stored in device information. As illustrated in FIG. 4, for example, a license code acquired by the authenticating unit 202, the device name of the device 20, and the type of the device 20 are stored in the device information. Further, regarding the device information, for example, the name of a CPU, the memory capacity, and the capacity of an HDD of the device 20 are stored as information for identifying parts among the components of the device 20.

Furthermore, from among information indicating the usage statuses of components of the device 20, information regarding parts of the device 20, such as the CPU usage, the memory usage, and the HDD usage, is stored in device information. The device information generating unit 203 calculates, for example, the CPU usage from the ratio of a time during which the CPU is being used (the ratio of a time during which the CPU is performing certain processing to a time during which the CPU is not performing any processing) to generate device information. Further, the device information generating unit 203 calculates the memory usage from the ratio of the amount of memory used (or free space) to the memory capacity, and calculates the HDD usage from the ratio of the amount of HDD used (or free space) to the HDD capacity, to generate device information. The device information generating unit 203 may calculate the daily average (the average value of numerical values calculated specified number of times a day) to generate device information.

Furthermore, from among information indicating the usage statuses of components of the device 20, information regarding a program, such as a BIOS date, the name and version information of an OS, the name and version information of software, and information regarding a principal process representing software whose execution time (activation time) at the device 20 is at a standard level or higher, is stored in device information. The device information generating unit 203 measures the activation time of each piece of software and acquires information regarding the principal process from the software whose startup time is at a standard level or higher to generate device information.

Furthermore, other types of information, such as the transmission network traffic amount and the reception network traffic amount of the device 20, the number of connected devices representing the number of devices or apparatuses connected to the device 20 through the communication network 2, and the number of files held in the device 20, are also stored in device information. The device information generating unit 203 measures, for example, the transmission (reception) network traffic amount and the number of connected devices, based on the communication status of the communication unit 23, and counts the number of files held in the device 20, to generate device information of the device 20. The device information generating unit 203 may calculate the daily average (the average value of numerical values measured specified number of times a day) to generate device information.

The device information illustrated in FIG. 4 is merely an example and device information is not limited to this. Device information may also include, for example, other types of information regarding the device 20 (for example, the temperature of the CPU, the renewal date of a specific electronic file, and the like). Alternatively, device information may also include other types of information, such as the name of a group to which the device 20 belongs.

The device information regarding the device 20 generated by the device information generating unit 203 is stored, for example, in the information storing unit 201.

### [3-4. Device Information Transmission Unit]

The device information transmitting unit 204 is generally implemented by the control unit 21 and the communication unit 23 of the device 20. The device information transmitting unit 204 transmits, for example, device information stored in the information storing unit 201 to the selection server 10 connected through the communication network 2.

For example, the device information transmitting unit 204 may include a timer and transmit the device information regularly. In this case, the device information transmitting unit 204 transmits the device information when the time measured by the timer has reached a specified time. Further, the device information transmitting unit 204 may, for example, transmit the device information when a predetermined time has been reached. Alternatively, the device information transmitting unit 204 may, for example, transmit the device information when receiving a request for device information from the selection server 10.

### [3-5. Device Information Acquiring Unit]

The device information acquiring unit 102 is generally implemented by the control unit 11 and the communication unit 13 of the selection server 10. The device information acquiring unit 102 acquires device information of multiple devices 20. The device information acquiring unit 102 also acquires device information representing the usage statuses of components of the multiple devices 20.

For example, the device information acquiring unit 102 acquires, through reception of device information transmitted from each of the devices 20, the device information regarding the device 20. The device information acquired by the device information acquiring unit 102 is stored, for example, in the information storing unit 101 of the selection server 10. The device information acquiring unit 102 may store device information in a chronological order by storing in the information storing unit 101 the date and time at which device information transmitted from each of the devices 20 was received, in association with the device information.

### [3-6. Candidate-to-be-replaced Selecting Unit]

The candidate-to-be-replaced selecting unit 103 is generally implemented by, for example, the control unit 11 of the selection server 10. The candidate-to-be-replaced selecting unit 103 selects, from among the multiple devices 20 and/or components of the devices 20, a candidate for a device 20 and/or a component to be replaced, based on the device information acquired by the device information acquiring unit 102. That is, the candidate-to-be-replaced selecting unit 103 selects, from among the multiple devices 20, a device 20 whose device information does not meet a predetermined criterion, as a candidate for a device 20 to be replaced. Further, when a component whose usage status does not meet a predetermined criterion exists, the candidate-to-be-replaced selecting unit 103 selects, from among multiple components, a candidate for a component to be replaced.

When the usage status of a part of the device 20 out of components of the devices 20 represented by device information does not meet a criterion defined for each type of part, the candidate-to-be-replaced selecting unit 103 selects the component or the device 20 as a candidate to be replaced.

For example, regarding the device information illustrated in FIG. 4, when a criterion defined for a CPU is “CPU usage: 40% or less”, the CPU of “PC-02” whose CPU usage exceeds the threshold “40%” and which does not meet the criterion is selected as a candidate to be replaced.

Further, for example, when a criterion defined for a memory is “memory usage: 70% or less”, memories of “PC-03” and “PC-04” whose memory usage exceeds the threshold “70%” and which do not meet the criterion are selected as candidates to be replaced. Furthermore, for example, when a criterion defined for an HDD is “HDD usage: 70% or less”, the HDD of “PC-04” whose HDD usage exceeds the threshold “70%” and which does not meet the criterion is selected as a candidate to be replaced.

In the case where the usage status of a part of a device 20 does not meet a criterion as described above, for example, the candidate-to-be-replaced selecting unit 103 may select the body of the device 20 as a candidate to be replaced or select a part different from the corresponding part as a candidate to be replaced. For example, when the CPU usage exceeds a threshold, the candidate-to-be-replaced selecting unit 103 may select a CPU fan as a candidate to be replaced.

Alternatively, when, from among components of the devices 20 represented by device information, version information or the release date of a program stored in a device 20 does not meet a criterion defined for each type of program, the candidate-to-be-replaced selecting unit 103 may select the program or the device 20 as a candidate to be replaced.

For example, when a criterion regarding BIOS is “BIOS date: 1/1/2005 or later”, the body of “Server-02” whose BIOS date is the day immediately before the threshold “1/1/2005” and which does not meet the criterion is selected as a candidate to be replaced.

In addition, for example, when a criterion regarding software “AAA” is “version information: 2.0 or later”, software “AAA” of “PC-04” which does not meet the criterion is selected as a candidate to be replaced. Replacement of software represents updating of the corresponding program or replacing the corresponding program with a different program.

In addition, the candidate-to-be-replaced selecting unit 103 may, for example, select a candidate to be replaced, based on version information (or release date) of a library necessary for opening an OS or software.

In addition, for example, the candidate-to-be-replaced selecting unit 103 may select, based on a combination of version information (or release date) of multiple programs having a dependence relationship, at least one of the multiple programs having the dependence relationship as a candidate to be replaced. In this case, for example, the information storing unit 101 may store information indicating the dependence relationship of the multiple programs, and the candidate-to-be-replaced selecting unit 103 may select a program having the dependence relationship as a candidate to be replaced by referring to the information indicating the dependence relationship.

Further, the candidate-to-be-replaced selecting unit 103 may acquire the various criteria mentioned above, for example, from information stored in the information storing unit 101. In addition, the candidate-to-be-replaced selecting unit 103 may acquire the above-mentioned various criteria through reception at the communication unit 13 of the selection server 10 or through reception of input from a user via the operation unit of the selection server 10.

Furthermore, the candidate-to-be-replaced selecting unit 103 may select a candidate to be replaced, based on device information whose license code matches a license code to be selected. In this case, a license code to be selected may be, for example, stored in the information storing unit 101 in advance, or may be acquired through reception by the communication unit 13 or through reception of input from a user at the selection server 10. As a license code to be selected, for example, a license code associated with a specific group name may be acquired from license information stored in the information storing unit 101.

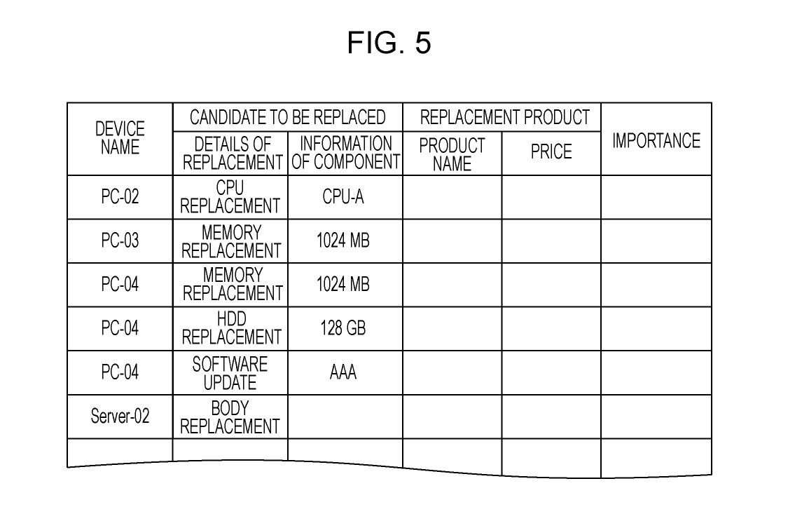

FIG. 5 is a diagram illustrating an example of a selection result by the candidate-to-be-replaced selecting unit 103. As illustrated in FIG. 5, for example, the candidate-to-be-replaced selecting unit 103 selects a candidate to be replaced, by acquiring a device name regarding the candidate to be replaced, the details of replacement for the device 20, and information of a component to be replaced, from device information acquired by the device information acquiring unit 102.

### [3-7. Product Selecting Unit 104]

The product selecting unit 104 is generally implemented by the control unit 11 of the selection server 10. The product selecting unit 104 selects, based on a selection result by the candidate-to-be-replaced selecting unit 103 and product information regarding multiple products that match a predetermined criterion, a device 20 to be replaced from among selected candidates, and a product with which the device 20 is to be replaced. The product selecting unit 104 also selects, based on a selection result by the candidate-to-be-replaced selecting unit 103 and product information regarding multiple products that meet a predetermined criterion, a component to be replaced from among selected candidates, and a product with which the component is to be replaced.

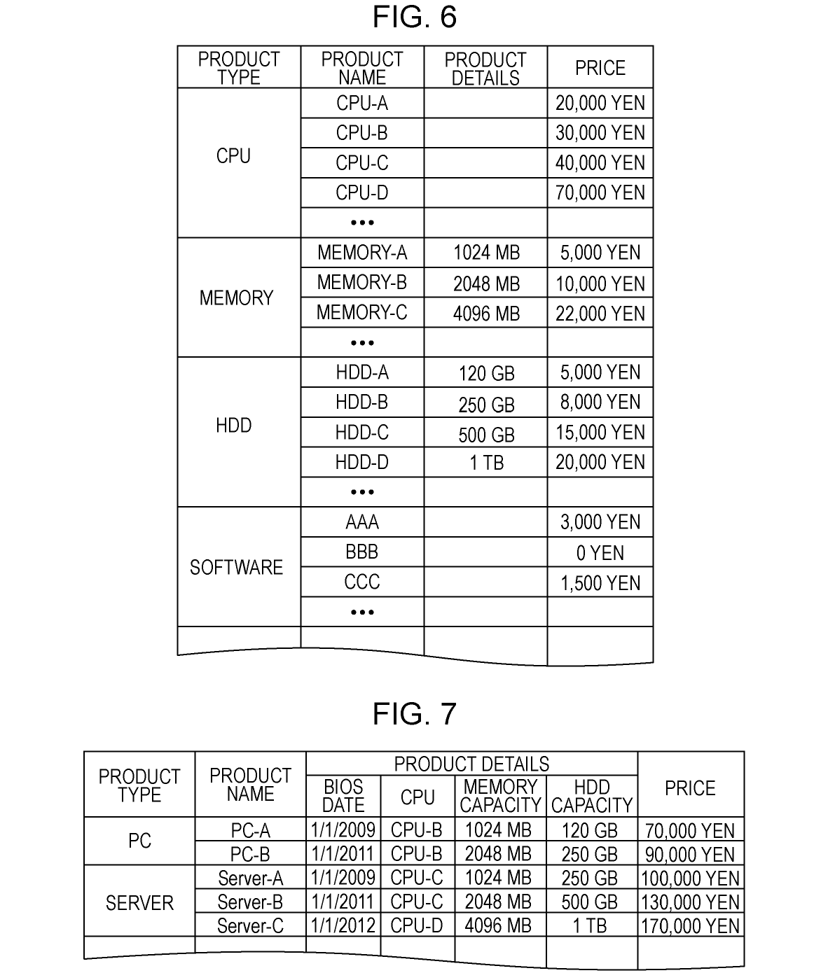

The product selecting unit 104 refers to, for example, product information stored in the information storing unit 101. FIGS. 6 and 7 are diagrams illustrating examples of product information. FIG. 6 is a diagram illustrating an example of product information regarding components (for example, parts and software) of the devices 20. FIG. 7 is a diagram illustrating an example of product information regarding the body of each of the devices 20. As illustrated in FIGS. 6 and 7, product information includes information regarding the price and performance of various products. The price of software represents the amount of money required for updating or replacement of software.

The product information illustrated in FIGS. 6 and 7 is merely examples and product information is not limited to the examples illustrated in FIGS. 6 and 7. In addition, for example, product information may include version information, the release date, the manufacturer, the model, and the like for identifying a product.

The product selecting unit 104 acquires, for example, the above-mentioned product information from information stored in the information storing unit 101. In addition, for example, the product selecting unit 104 may acquire the product information through reception at the communication unit 13 of the selection server 10 or through reception of input from a user via the operation unit of the selection server 10.

The product selecting unit 104 may select a replacement product with which a candidate selected by the candidate-to-be-replaced selecting unit 103 is to be replaced, and may make a selection based on information regarding the price of the selected product and information of the budget of a user.

Furthermore, the product selecting unit 104 may, for example, make a selection based on the importance of a candidate selected by the candidate-to-be-replaced selecting unit 103.

In the exemplary embodiment, the product selecting unit 104 includes, for example, a device selecting part 105, a product candidate selecting part 106, an importance calculating part 107, and a budget information acquiring part 108.

### [3-7-1. Device Selecting Part]

For example, in the case where a candidate selected by the candidate-to-be-replaced selecting unit 103 is the body or a specific part (for example, a CPU or the like) of a device 20, the device selecting part 105 selects, from among the multiple devices 20, a different device 20 that is different from the device 20 regarding the candidate selected by the candidate-to-be-replaced selecting unit 103. In this case, the product selecting unit 104 makes a selection based on device information regarding the different device 20.

Here, device information of the different device 20 selected by the device selecting part 105 meets a criterion. Therefore, the device 20 is determined not to need to be replaced. In this case, the product selecting unit 104 makes a selection based on device information of the device 20 that does not need to be replaced.

The device selecting part 105 may, for example, select the different device 20 whose purpose matches or is similar to that of the device 20 regarding the candidate selected by the candidate-to-be-replaced selecting unit 103. In this case, the product selecting unit 104 makes a selection based on device information of the different device 20 whose purpose matches or is similar to that of the device 20 regarding the candidate to be replaced.

Here, the purpose of the device 20 is identified, for example, based on the type, the OS, the principal process, and the like of the device 20 of device information. Here, the case where the purpose is the same between devices represents the case where all the elements mentioned above match between the devices. Further, the case where the purpose is similar between devices represents the case where at least one of the elements mentioned above matches between the devices. The device selecting part 105 selects, for example, a different device 20 having device information of which all of the type, the OS, and the principal process match those of device information of the device 20 regarding the selected candidate or a different device 20 having device information of which at least one of the elements mentioned above matches that of the device information of the device 20 regarding the selected candidate.

In addition, for example, the device selecting part 105 may select the different device 20, based on a group to which the device 20 regarding the candidate selected by the candidate-to-be-replaced selecting unit 103 belongs. In this case, the product selecting unit 104 makes a selection based on a group to which the device 20 regarding the candidate selected by the candidate-to-be-replaced selecting unit 103, from among the multiple devices 20, belongs.

Here, the group name of the device 20 is, for example, associated with a license code stored in device information. For example, the name of a group to which “Server-02” belongs is “Company A” which is associated with license code “001” in license information.

For example, in the case where the CPU of “PC-02” is selected by the candidate-to-be-replaced selecting unit 103 as a candidate to be replaced, the device selecting part 105 selects, as a different device 20, “PC-01” of which all information representing the purpose (the type, OS, and principal process of the device 20) and the group name match those of “PC-02” and whose body or component is not selected as a candidate to be replaced.

Furthermore, for example, in the case where “Server-02” is selected by the candidate-to-be-replaced selecting unit 103 as a candidate to be replaced, the device selecting part 105 selects, as a different device 20, “Server-01” of which part (the type and OS of the device 20) of information representing the purpose and the group name match those of “Server-02” and whose body or component is not selected as a candidate to be replaced.

For example, in the case where a different device 20 whose purpose matches that of the device 20 to be replaced is not found in the same group, the device selecting part 105 may acquire a group that is similar to the corresponding group in license information and select the different device 20. Here, the case where a group is similar to another group represents, for example, the case where the group type is the same between the groups and the group size is the same between the groups or a difference in the group size between the groups is smaller than or equal to a reference value.

The device selecting part 105 may, for example, select a device 20 which belongs to “Company B”, which is a group similar to “Company A”. The device selecting part 105 may, for example, select “Server-03” of which all information regarding the purpose of the device 20 (the type, OS, and principal process of the device 20) matches that of “Server-02”, of which the group to which the device belongs is similar to that of “Server-02”, and whose body or component is not selected as a candidate to be replaced.

### [3-7-2. Product Candidate Selecting Part]

The product candidate selecting part 106 selects a replacement product (hereinafter, also referred to as a “product candidate”) with which a candidate selected by the candidate-to-be-replaced selecting unit 103 is to be replaced.

For example, in the case where a candidate selected by the candidate-to-be-replaced selecting unit 103 is the body or a specific part (for example, a CPU or the like) of a device 20, the product candidate selecting part 106 selects a product candidate which matches or is similar to the body or a part of a different device 20 selected by the device selecting part 105.

The product candidate selecting part 106 selects, for example, for the CPU of “PC-02” serving as a candidate to be replaced, “CPU-B” that matches the CPU of “PC-01” selected by the device selecting part 105, as a product candidate.

In the case where product information does not include “CPU-B”, the product candidate selecting part 106 may, for example, select a product candidate which is similar to “CPU-B”, based on information of the type (name), the number of clocks, the number of cores, and the like of “CPU-B”.

Further, for example, in the case where “Server-01” is selected by the device selecting part 105 for the body of “Server-02” serving as a candidate to be replaced, the product candidate selecting part 106 selects “Server-B” whose CPU, memory capacity, and HDD capacity match those of “Server-01”, as a product candidate.

For example, in the case where “Server-03” is selected by the device selecting part 105 for the body of “Server-02” serving as a candidate to be replaced, the product candidate selecting part 106 may select “Server-C” whose CPU and memory capacity match those of “Server-03”, as a product candidate.

In addition, for example, in the case where a candidate selected by the candidate-to-be-replaced selecting unit 103 is a part (for example, a memory, an HDD, or the like) that is different from the specific part, the product candidate selecting part 106 selects, for example, a product candidate having a performance higher than the selected candidate, from product information.

For example, the product candidate selecting part 106 selects, for a memory of “PC-03” serving as a candidate to be replaced, “memory-B” whose capacity is greater than the memory capacity (1024 MB). Further, for example, the product candidate selecting part 106 selects, for a memory of “PC-04” serving as a candidate to be replaced, “memory-C” whose capacity is greater than the memory capacity (2048 MB), and for an HDD of “PC-04” serving as the candidate to be replaced, “HDD-B” whose capacity is greater than the HDD capacity (120 GB).

In the case where the product candidate selecting part 106 selects a product for a memory serving as a candidate to be replaced, the product candidate selecting part 106 may select a memory which meets a criterion regarding a memory “memory usage: 70% or less”. For example, since the used amount of memory of “PC-03” is about 922 MB (1024 MB×0.9), a memory which is to be selected here needs a memory capacity of at least 1318 MB (922 MB/0.7) or more. Therefore, the product candidate selecting part 106 may, for example, calculate a condition regarding the performance of a product, based on a criterion regarding a candidate selected by the candidate-to-be-replaced selecting unit 103, and select a product that meets the calculated condition, as a product candidate with which the selected candidate is to be replaced.

Further, the product candidate selecting part 106 may, for example, select a product candidate of the lowest price from among product candidates that meet a condition of a replacement product with which a candidate to be replaced is to be replaced.

In addition, for example, in the case where a candidate selected by the candidate-to-be-replaced selecting unit 103 is a program, the product candidate selecting part 106 selects, for example, a product candidate that is the same product as and that is newer than the selected candidate, from product information. For example, the product candidate selecting part 106 selects, for software “AAA” of “PC-04” serving as a candidate to be replaced, the latest version of “AAA” in product information.

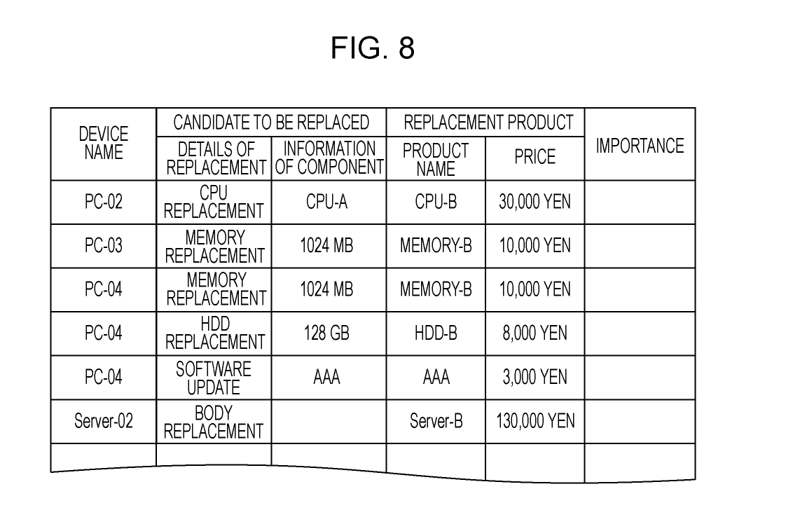

FIG. 8 is a diagram illustrating an example of a selection result by the product candidate selecting part 106. As illustrated in FIG. 8, the product candidate selecting part 106 selects, for a candidate to be replaced, a replacement product candidate with which the candidate to be replaced is to be replaced, and acquires the name and price of the selected product candidate.

### [3-7-3. Importance Calculating Part]

The importance calculating part 107 calculates, based on device information, the importance of a candidate selected by the candidate-to-be-replaced selecting unit 103. The importance of a candidate represents an index value indicating the replacement priority of the candidate.

For example, the importance calculating part 107 calculates, for example, the importance of the selected candidate, based on weighting information of the importance.

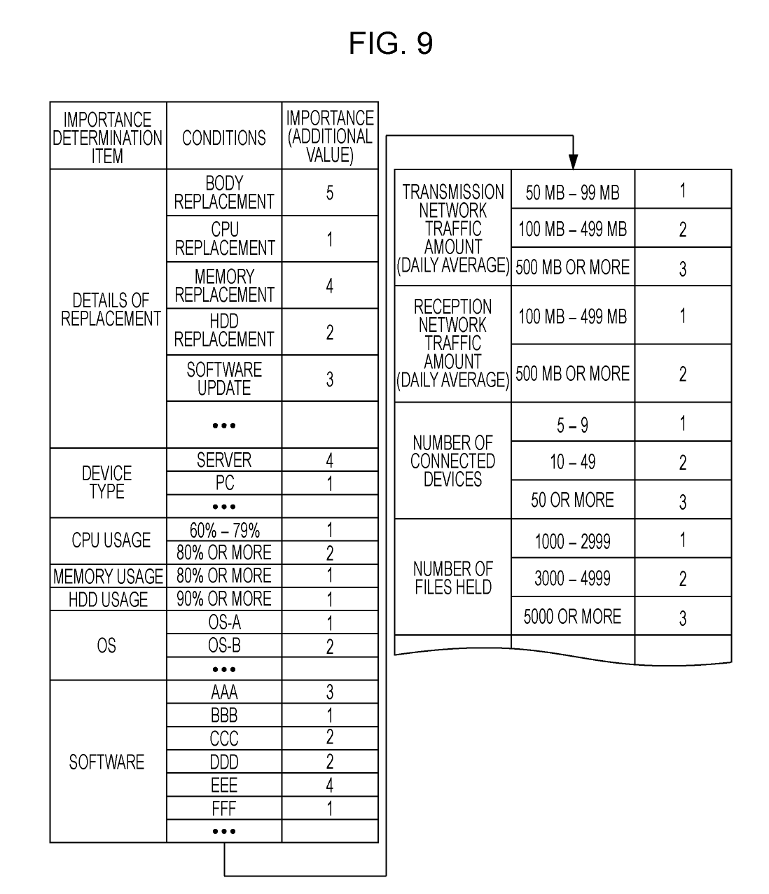

FIG. 9 is a diagram illustrating an example of weighting information. For example, the importance calculating part 107 refers to weighting information and determines whether or not device information regarding a candidate selected by the candidate-to-be-replaced selecting unit 103 meets a condition set for each importance determination item. When the device information meets the condition, the importance calculating part 107 adds an additional value of the importance set for the condition to the importance of the candidate.

For example, in the case where the details of replacement for a candidate selected by the candidate-to-be-replaced selecting unit 103 indicate “CPU replacement”, as illustrated in FIG. 9, “1” is added to the importance of the candidate. In the case where the details of the replacement indicate “memory replacement”, “2” is added to the importance of the candidate.

Further, for example, in the case where the type of a device 20 regarding a candidate selected by the candidate-to-be-replaced selecting unit 103 is “server”, “3” is added to the importance of the candidate. Further, in the case where the type of the device 20 is “PC”, “1” is added to the importance of the candidate.

Furthermore, for example, an additional value set for each condition, in accordance with the usage status (for example, CPU usage, memory usage, HDD usage, or the like) of a part out of the usage statuses of components of the device 20 selected as a candidate by the candidate-to-be-replaced selecting unit 103, may be added to the importance of the candidate.

Furthermore, for example, an additional value set for each condition, in accordance with information (for example, the OS, software, or the like) of a program stored in a device 20 regarding a candidate selected by the candidate-to-be-replaced selecting unit 103, may be added to the importance of the candidate.

Furthermore, for example, in the case where the transmission network traffic amount, the reception network traffic amount, the number of connected devices, and the number of files held of a device 20 regarding a candidate selected by the candidate-to-be-replaced selecting unit 103 meet conditions defined individually, the importance of the candidate may be added.

The weighting information illustrated in FIG. 9 is merely an example and weighting information is not limited to this. For example, second, third, and other conditions may be set for the weighting information. In this case, in the case where all the defined conditions are met (or at least one of the conditions is met), the importance calculating part 107 may add an additional value set for the corresponding conditions (or condition) to the importance of a candidate to be replaced.

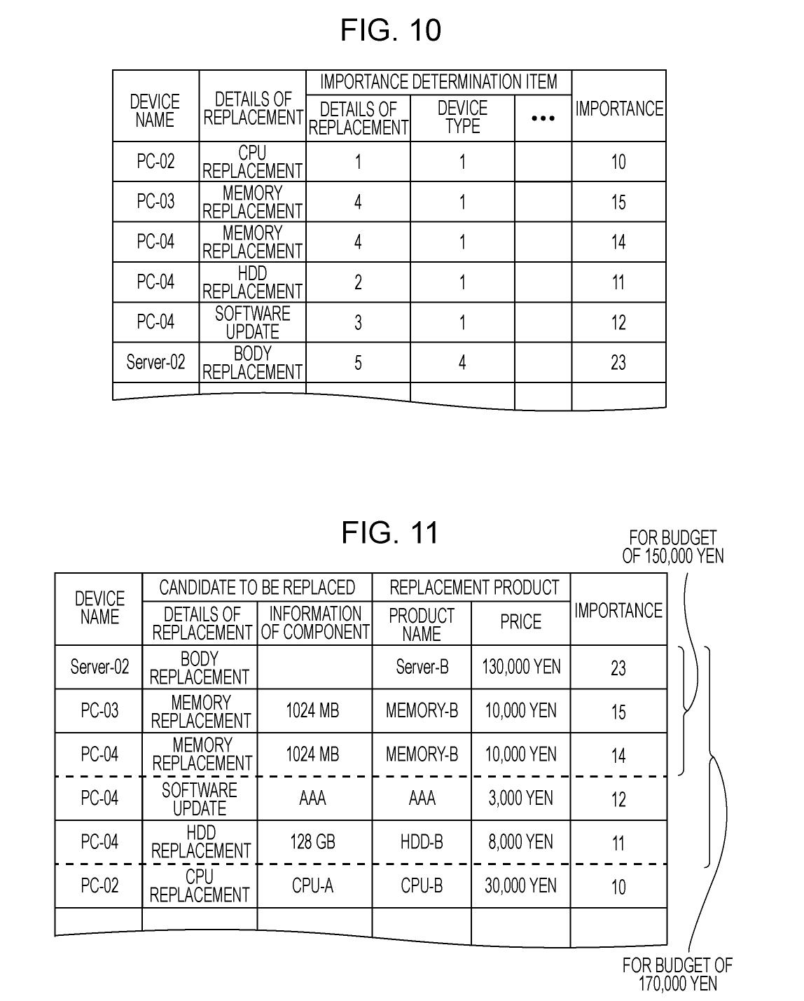

FIG. 10 is a diagram illustrating an example of a calculation result by the importance calculating part 107. For example, as illustrated in FIG. 10, the importance calculating part 107 calculates the importance of a candidate selected by the candidate-to-be-replaced selecting unit 103 by adding an additional value of an importance set for each importance determination item.

### [3-7-4. Budget Information Acquiring Part]

The budget information acquiring part 108 acquires information of the budget of a user. The budget information acquiring part 108 acquires, for example, information of a budget that may be used for replacement of a device 20 and/or a component of a device 20 from information stored in the information storing unit 101. The budget information acquiring part 108 acquires, for example, information of a budget associated with a license code input by a user, out of information of budgets stored in license information. In addition, for example, the budget information acquiring part 108 may acquire information of a budget through reception at the communication unit 13 of the selection server 10 or through reception of input from a user via the operation unit of the selection server 10.

For example, the product selecting unit 104 makes a selection based on the importance calculated by the importance calculating part 107 and information on the budget of a user acquired by the budget information acquiring part 108.

FIG. 11 is a diagram illustrating an example of a selection result by the product selecting unit 104. As illustrated in FIG. 11, for example, the product selecting unit 104 sorts candidates selected by the candidate-to-be-replaced selecting unit 103 in descending order of priority, and makes a selection in accordance with the sorted order in such a manner that the total sum of the prices of replacement products with which the candidates are to be replaced does not exceed the budget of a user acquired by the budget information acquiring part 108.

In FIG. 11, for example, in the case where the budget of a user is 150,000 yen, the product selecting unit 104 selects a device 20, components, and replacement products with which the device 20 and the components are to be replaced in such a manner that the total sum of the prices of the replacement products does not exceed the budget of the user, as described below.
Body of “Server-02” and “Server-B”
Memory of “PC-03” and “memory-B”
Memory of “PC-04” and “memory-B”

Further, for example, in FIG. 11, in the case where the budget of a user is 170,000 yen, the product selecting unit 104 selects components and replacement products with which the components are to be replaced, as described below, in addition to the product group mentioned above.
Software “AAA” of “PC-04” and latest version of “AAA”
HDD of “PC-04” and “HDD-B”

For example, the product selecting unit 104 may make a selection based on a replacement product with which a candidate selected by the candidate-to-be-replaced selecting unit 103 is to be replaced, without depending on the importance of the candidate. For example, the product selecting unit 104 may select a device 20 and/or a component of a device 20 to be replaced, and replacement products/a replacement product with which the device 20 and/or the component of the device 20 are/is to be replaced, in ascending order of product price, so that the total sum of the prices of the products does not exceed the budget of a user.

Further, for example, the product selecting unit 104 may make a selection based on, for example, the importance of a candidate selected by the candidate-to-be-replaced selecting unit 103, without depending on the prices of products and the budget of a user. The product selecting unit 104 may, for example, select candidates up to the n-th candidate (n represents a natural number), out of the selected candidates, in descending order of priority, and replacement products with which the candidates are to be replaced. In this case, after the importance is calculated by the importance calculating part 107, the product selecting unit 104 may select a product candidate selected by the product candidate selecting part 106 as a replacement product.

### [4. Processing Performed in Selection System]

Next, processing performed by the selection system 1 in the exemplary embodiment will be explained.

### [4-1. Overall Process]

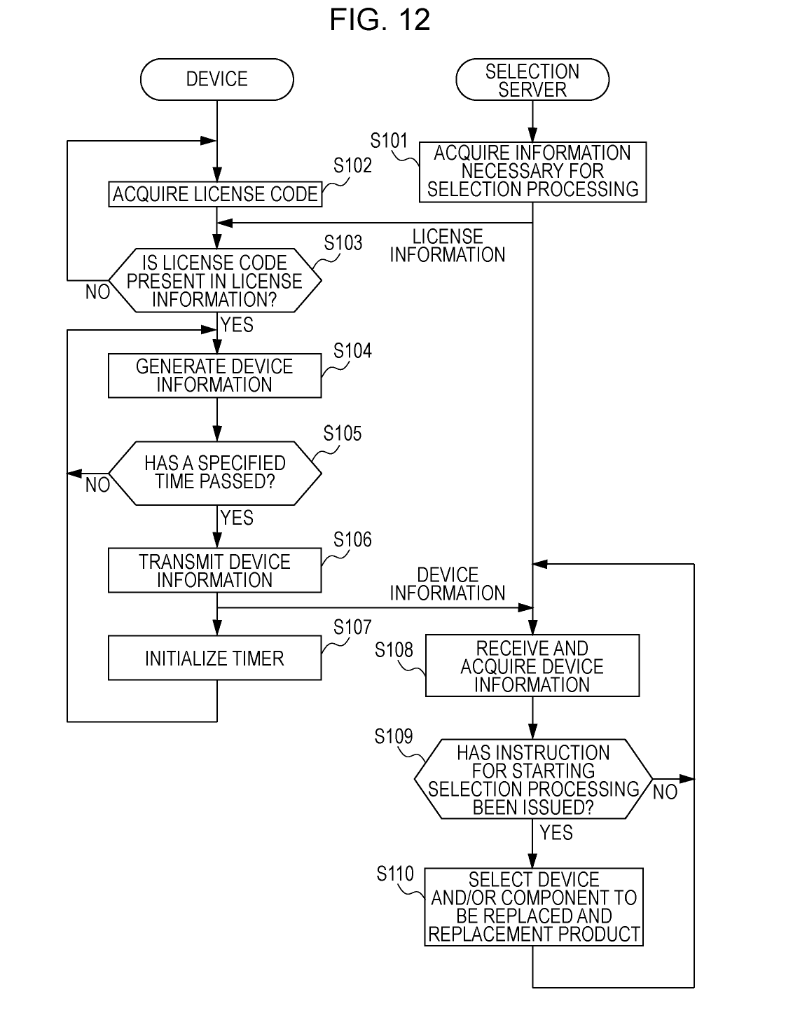

FIG. 12 is a sequence diagram illustrating an example of a process performed by the selection system 1. A process in which device information of devices 20 is transmitted to the selection server 10 and selection processing for selecting a device 20 and/or a component of a device 20 to be replaced, and replacement products/a replacement product with which the device 20 and/or the component of the device 20 are/is to be replaced, will be described below.

As illustrated in FIG. 12, first, the control unit 11 of the selection server 10 acquires information necessary for selection processing (S101). Specifically, the control unit 11 acquires license information indicating a list of license codes, information indicating criteria set for individual components of the devices 20, product information regarding multiple products, and weighting information indicating an additional value of an importance, and stores the acquired information into the storage unit 12 of the selection server 10. The information mentioned above may be acquired through reception at the communication unit 13 of the selection server 10 or through reception of input from a user via the operation unit of the selection server 10.

The control unit 21 of the device 20 acquires a license code through reception of input from a user or from information stored in the storage unit 22 (S102). The control unit 21 refers to the license information stored in the storage unit 12 of the selection server 10, and determines whether or not the license code acquired in S102 is present in the license information (S103).

In the case where the license code acquired in S102 is present in the license information (Yes in S103), the control unit 21 generates device information of the device 20 (device information indicating the usage statuses of components of the device 20) (S104). The control unit 21 measures the elapsed time of a timer (S105). When a specified time has passed (YES in S105), the control unit 21 transmits to the selection server 10 the device information generated in S104 (S106), and initializes the elapsed time of the timer (S107). The control unit 21 controls device information to be in the latest state by sequentially generating (or updating) device information regarding the device 20 (S104). The control unit 21 may transmit device information, for example, when a predetermined time is reached, without performing the processing in S105 and S107.

The control unit 11 of the selection server 10 acquires device information of the device 20 by receiving the device information transmitted in S106 (S108). The control unit 11 determines whether or not an instruction for starting the selection processing has been issued by the user (S109). In the case where it is determined that the instruction for starting the selection processing has been issued (YES in S109), the control unit 11 selects, from among multiple devices 20, a device 20 to be replaced and/or a component to be replaced, and replacement products/a replacement product with which the device 20 and/or the component to be replaced are/is to be replaced (S110). The control unit 11 controls device information of the devices 20 to be in the latest state by sequentially receiving and acquiring the device information regarding the devices 20 (S108).

### [4-2. Selection Processing]

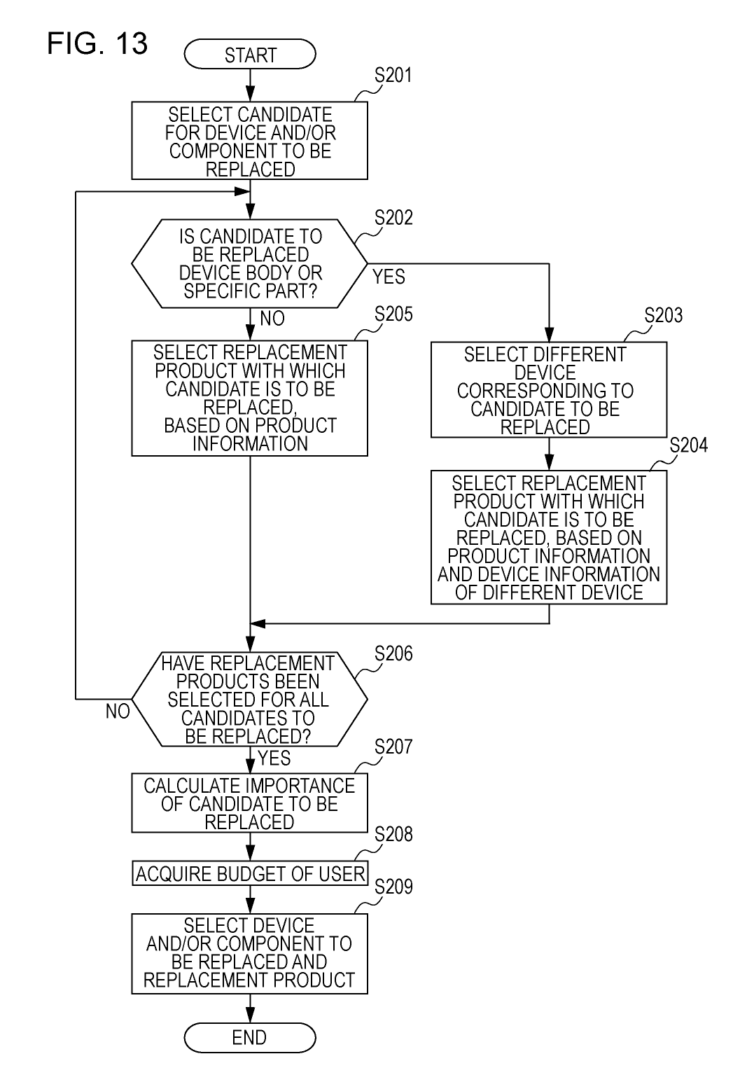

Next, the details of the selection processing performed in S110 will be explained. FIG. 13 is a flowchart illustrating an example of selection processing. As illustrated in FIG. 13, the control unit 11 of the selection server 10 selects, based on the device information acquired in S108, a candidate for a device 20 to be replaced and/or a candidate for a component to be replaced (candidate/candidates to be replaced), from among the multiple devices 20 (S201). That is, in S201, the control unit 11 selects a device 20 whose device information does not meet a predetermined criterion, from among the multiple devices 20, as a candidate for a device 20 to be replaced. Furthermore, in S201, in the case where a component whose usage status does not meet a predetermined criterion exists, the control unit 11 selects a candidate for a component to be replaced, from among multiple components.

For example, the control unit 11 compares the device information acquired in S108 with criteria (for example, the CPU usage, BIOS date, version information of a program, and the like) defined based on components of the devices 20, and selects a candidate to be replaced, as illustrated in FIG. 5, from among devices 20 and components that do not meet the criteria.

The control unit 11 determines whether or not the candidate to be replaced selected in S201 is the body and/or a specific part of the device 20 (S202). When the selected candidate is the body or a specific part of the device 20 (YES in S202), the control unit 11 selects a different device 20 corresponding to the candidate to be replaced (S203), and selects, based on product information regarding multiple products that meet a predetermined criterion and device information of the different device 20 selected in S203, a replacement product (product candidate) with which the candidate to be replaced is to be replaced (S204).

For example, in the case where the candidate to be replaced selected in S201 is a CPU, the control unit 11 selects a different device 20 of which at least one of the type, OS, and principal process matches those of the device 20 regarding the candidate and of which the name of a group matches or is similar to the name of the group to which the device 20 belongs, and selects, from among products represented by product information, a product which matches or is similar to the CPU of the different device 20 as a product candidate with which the CPU serving as a candidate to be replaced is to be replaced.

In the case where the candidate to be replaced selected in S201 is a component different from a specific part (NO in S202), the control unit 11 selects, based on product information regarding multiple products that meet a predetermined criterion, a replacement product (product candidate) with which the candidate to be replaced is to be replaced (S205).

For example, in the case where the candidate to be replaced selected in S201 is a memory, the control unit 11 selects a memory whose capacity is greater than the memory from product information, and defines the memory as a product candidate with which the candidate to be replaced is to be replaced.

The control unit 11 determines whether or not replacement products for all the candidates to be replaced have been selected (S206), and repeats the selection processing for product candidates (S202 to S205) until product candidates with which all the candidates to be replaced are to be replaced have been selected (YES in S206). As illustrated in FIG. 8, the control unit 11 selects product candidates for all the candidates to be replaced.

The control unit 11 calculates the importance of the candidate to be replaced selected in S201 (S207). The control unit 11 acquires information of the budget of a user for replacement of a device 20 and/or a component of a device 20 (S208). The control unit 11 selects, from among the selected candidates, a device 20 to be replaced and/or a component to be replaced, and replacement products/a replacement product with which the device 20 to be replaced and/or the component to be replaced are/is to be replaced (S209), and terminates the processing of S110.

For example, as illustrated in FIG. 11, the control unit 11 makes a selection based on the order of importances calculated in S206 in such a manner that the total sum of the prices of replacement products with which the candidates selected in S201 are to be replaced does not exceed the budget of the user acquired in S207.

S202 to S206 and S207 may be exchanged with each other. That is, after performing the processing for selecting a candidate to be replaced in S201, the control unit 11 may calculate the importance of the candidate in S207, and then select a replacement product with which a candidate whose importance is determined to be high is to be replaced in the processing of S202 to S206 and S209. In this case, the control unit 11 may select a device 20 or component to be replaced and a replacement product, irrespective of the budget of a user, without performing processing for acquiring the budget in S208.

Further, the control unit 11 may make a selection without performing processing for calculating an importance in S207. In this case, for example, the control unit 11 may make a selection in ascending order of product price.

### [5. Conclusion]

In the selection system 1 according to the exemplary embodiment, device information regarding multiple devices 20 is acquired, and a device 20 to be replaced and/or a component to be replaced, and replacement products/a replacement product with which the device 20 and/or the component to be replaced are/is to be replaced, are selected from among the multiple devices 20. For example, the selection system 1 selects a replacement configuration (a combination of a device 20 or a component to be replaced, and a replacement product) in order to achieve optimization of the entire system.

Furthermore, the selection system 1 acquires product information regarding multiple products and information of the budget of a user, and makes a selection based on the prices of the products and the budget of the user. Furthermore, the selection system 1 calculates the importance of a candidate to be replaced, and makes a selection based on the importance of the candidate to be replaced. For example, the selection system 1 selects a replacement configuration having the highest cost effectiveness, among replacement configurations that optimize the entire system.

Furthermore, in the selection system 1, the devices 20 transmit device information to the selection server 10, and the selection server 10 receives and acquires the device information, and makes a selection based on the device information transmitted from the multiple devices 20. In addition, since device information is regularly transmitted from the devices 20 to the selection server 10, the device information is maintained in the latest state.

Furthermore, the selection system 1 makes a selection based on device information of a device 20 that does not need to be replaced, through selection of a different device 20 that is different from the device 20 selected as a candidate to be replaced. For example, the selection system 1 selects a replacement product, from among devices 20 which are approved as operating normally.

Furthermore, the selection system 1 makes a selection based on a device 20 whose purpose matches or is similar to a device 20 regarding a candidate to be replaced, through selection of a different device 20 whose purpose matches or is similar to the device 20 regarding the candidate to be replaced. For example, the selection system 1 selects a replacement product from among devices 20 which are used in a way similar to a device 20 to be replaced (or a device 20 including a component to be replaced) and are approved as operating normally.

Furthermore, the selection system 1 makes a selection based on a group to which a device 20 regarding a candidate to be replaced belongs, through selection of a different device 20 based on the group to which the device 20 regarding the candidate to be replaced belongs. For example, the selection system 1 selects a replacement product from among devices 20 or components by other companies in the same industry.

The present invention is not limited to the exemplary embodiment described above, and modifications may be made to the present invention in an appropriate manner without departing from the scope of the present invention.

### [6. Exemplary Variations]

(Exemplary Variation 1)

In the exemplary embodiment, the case where the authenticating unit 202 acquires a license code and execution of device information generation processing by the device information generating unit 203 and device information transmission processing by the device information transmitting unit 204 is approved based on the license code and license information stored in the information storing unit 101, has been explained. For example, the selection system 1 may perform the device information generation processing and the device information transmission processing, without the above-mentioned approval.

(Exemplary Variation 2)

Further, in the exemplary embodiment, the case where a group name and budget information associated with the acquired license code are acquired, has been explained. For example, the selection system 1 may identify the name of a group to which a device 20 belongs and budget information of the device 20, without acquiring a license code.

The information storing unit 101 in exemplary variation 2 may, for example, store group information in which the device name of a device 20 and information regarding a group to which the device 20 belongs (for example, the group name, group type, group size, and the like) are associated with each other, and the device selecting part 105 in exemplary variation 2 may select, based on information of a group name and the like associated with the device name of the device information, a different device 20 that is different from the device 20 regarding a candidate to be replaced. Further, the information storing unit 101 in exemplary variation 2 may store information of the budget of a user, and the budget information acquiring part 108 in exemplary variation 2 may acquire the information of the budget stored in the information storing unit 101.

As describe above, the selection system 1 according to exemplary variation 2 identifies the name of a group to which a device 20 belongs and information of the budget, without acquiring a license code, and selects a device 20 to be replaced and/or a component to be replaced, and replacement products/a replacement product.

(Exemplary Variation 3)

Further, in the exemplary embodiment, the case where when the body or a specific part (for example, a CPU or the like) is selected as a candidate to be replaced, the product candidate selecting part 106 selects a product (product candidate) which matches or is similar to the body or a part of a different device 20 that is different from the device 20 regarding the candidate, has been explained. The product candidate selecting part 106 may, for example, select, from product information, a product candidate that has a performance higher than the body or the specific part, such as a CPU, of the device 20 to be replaced, without selecting a different device 20.

(Exemplary Variation 4)

Furthermore, for example, the candidate-to-be-replaced selecting unit 103 may select, from among components of the devices 20, a consumable or wear item (for example, printing paper, toner, a buttery, a CPU fan, or the like) as a candidate to be replaced. In this case, the product selecting unit 104 may select the same product (or a product of the same model) as the selected candidate to be replaced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A selection system comprising:
an acquiring unit that acquires device information of a plurality of devices;
a candidate selecting unit that selects, from among the plurality of devices, a device whose device information does not meet a predetermined criterion, as a candidate for a device to be replaced; and
a product selecting unit that selects, based on a selection result by the candidate selecting unit and product information regarding a plurality of products that meet the predetermined criterion, a device to be replaced, from among candidates selected, and a replacement product with which the device is to be replaced.

2. A selection system comprising:
an acquiring unit that acquires device information indicating usage statuses of a plurality of components of devices;
a candidate selecting unit that selects, in a case where a component whose usage status does not meet a predetermined criterion exists, a candidate for a component to be replaced, from among the plurality of components; and
a product selecting unit that selects, based on a selection result by the candidate selecting unit and product information regarding a plurality of products, a component to be replaced, from among candidates selected, and a replacement product with which the component is to be replaced.

3. The selection system according to claim 1,
wherein the product information includes information regarding prices of the individual products,
wherein the product selecting unit includes a budget information acquiring part that acquires information of a budget of a user, and a replacement product selecting part that selects the replacement product with which the selected candidate is to be replaced, and
wherein the product selecting unit makes a selection based on the acquired information of the budget of the user and the information regarding the price of the selected product.

4. The selection system according to claim 2,
wherein the product information includes information regarding prices of the individual products,
wherein the product selecting unit includes a budget information acquiring part that acquires information of a budget of a user, and a replacement product selecting part that selects the replacement product with which the selected candidate is to be replaced, and
wherein the product selecting unit makes a selection based on the acquired information of the budget of the user and the information regarding the price of the selected product.

5. The selection system according to claim 1,
wherein the product selecting unit includes an importance calculating part that calculates an importance regarding the selected candidate, based on the device information, and makes a selection based on the calculated importance.

6. The selection system according to claim 2,
wherein the product selecting unit includes an importance calculating part that calculates an importance regarding the selected candidate, based on the device information, and makes a selection based on the calculated importance.

7. The selection system according to claim 1, further comprising:
a selection server that is connected to the individual devices through a communication network,
wherein the selection server includes the acquiring unit, the candidate selecting unit, and the product selecting unit,
wherein each of the devices includes a device information generating unit that generates the device information, and a device information transmitting unit that transmits the generated device information to the selection server through the communication network, and
wherein the acquiring unit of the selection server acquires the device information through reception of the transmitted device information.

8. The selection system according to claim 2, further comprising:
a selection server that is connected to the individual devices through a communication network,
wherein the selection server includes the acquiring unit, the candidate selecting unit, and the product selecting unit,
wherein each of the devices includes a device information generating unit that generates the device information, and a device information transmitting unit that transmits the generated device information to the selection server through the communication network, and
wherein the acquiring unit of the selection server acquires the device information through reception of the transmitted device information.

9. The selection system according to claim 1,
wherein the product selecting unit makes a selection based on device information of a different device that is different from the device regarding the selected candidate, from among the plurality of devices.

10. The selection system according to claim 2,
wherein the product selecting unit makes a selection based on device information of a different device that is different from the device regarding the selected candidate, from among the plurality of devices.

11. The selection system according to claim 9,
wherein the device information includes information regarding purposes of the devices, and
wherein the product selecting unit makes a selection based on device information of a different device whose purpose matches or is similar to a purpose of the device regarding the selected candidate.

12. The selection system according to claim 10,
wherein the device information includes information regarding purposes of the devices, and
wherein the product selecting unit makes a selection based on device information of a different device whose purpose matches or is similar to a purpose of the device regarding the selected candidate.

13. The selection system according to claim 1,
wherein each of the devices belongs to a corresponding one of a plurality of groups, and
wherein the product selecting unit makes a selection based on a group to which the device regarding the selected candidate belongs, from among the plurality of devices.

14. The selection system according to claim 2,
wherein each of the devices belongs to a corresponding one of a plurality of groups, and
wherein the product selecting unit makes a selection based on a group to which the device regarding the selected candidate belongs, from among the plurality of devices.

15. A selection server comprising:
an acquiring unit that acquires device information of a plurality of devices;
a candidate selecting unit that selects, from among the plurality of devices, a device whose device information does not meet a predetermined criterion, as a candidate for a device to be replaced; and
a product selecting unit that selects, based on a selection result by the candidate selecting unit and product information regarding a plurality of products that meet the predetermined criterion, a device to be replaced, from among candidates selected, and a replacement product with which the device is to be replaced.

16. A selection server comprising:
an acquiring unit that acquires device information indicating usage statuses of a plurality of components of devices;
a candidate selecting unit that selects, in a case where a component whose usage status does not meet a predetermined criterion exists, a candidate for a component to be replaced, from among the plurality of components; and
a product selecting unit that selects, based on a selection result by the candidate selecting unit and product information regarding a plurality of products, a component to be replaced, from among candidates selected, and a replacement product with which the component is to be replaced.

17. A selection method comprising:
acquiring device information of a plurality of devices;
selecting, from among the plurality of devices, a device whose device information does not meet a predetermined criterion, as a candidate for a device to be replaced; and
selecting, based on a selection result and product information regarding a plurality of products that meet the predetermined criterion, a device to be replaced, from among candidates selected, and a replacement product with which the device is to be replaced.

18. A selection method comprising:
acquiring device information indicating usage statuses of a plurality of components of devices;
selecting, in a case where a component whose usage status does not meet a predetermined criterion exists, a candidate for a component to be replaced, from among the plurality of components; and
selecting, based on a selection result and product information regarding a plurality of products, a component to be replaced, from among candidates selected, and a replacement product with which the component is to be replaced.

19. A non-transitory computer readable medium storing a program causing a computer to execute a process for selection, the process comprising:
acquiring device information of a plurality of devices;
selecting, from among the plurality of devices, a device whose device information does not meet a predetermined criterion, as a candidate for a device to be replaced; and
selecting, based on a selection result and product information regarding a plurality of products that meet the predetermined criterion, a device to be replaced, from among candidates selected, and a replacement product with which the device is to be replaced.

20. A non-transitory computer readable medium storing a program causing a computer to execute a process for selection, the process comprising:
acquiring device information indicating usage statuses of a plurality of components of devices;
selecting, in a case where a component whose usage status does not meet a predetermined criterion exists, a candidate for a component to be replaced, from among the plurality of components; and
selecting, based on a selection result and product information regarding a plurality of products, a component to be replaced, from among candidates selected, and a replacement product with which the component is to be replaced.
